(19) United States
(12) Patent Application Publication
(10) Pub. No.: US 2004/0084112 A1
(43) Pub. Date: May 6, 2004

(54) Insulating coating with ferromagnetic particles

(75) Inventors: Amitabh Verma, Bangalore (IN); Luana Emiliana Iorio, Clifton Park, NY (US); K. Anand, Bangalore (IN); Srinidhi Sampath, Bangalore (IN); Kanchan Kumari, Bangalore (IN); Geetha Karavoor, Kerala (IN)

Correspondence Address: GENERAL ELECTRIC COMPANY, GLOBAL RESEARCH, PATENT DOCKET RM. BLDG. K1-4A59, SCHENECTADY, NY, 12301-0008, US

(73) Assignee: General Electric Company

(21) Appl. No.: 10/287,884

(22) Filed: Nov. 5, 2002

(51) Int. Cl. H01F 1/06; H01F 1/36

(52) U.S. Cl. 148/105; 428/552

(57) ABSTRACT

Ferromagnetic particles with a high-temperature and thermally stable insulating coating are described. The ferromagnetic particles are first coated with a thin layer of a high permeability metal (nickel) by an electroless plating process. The deposited metal layer is then oxidized by controlling the time and temperature while heating the coated particles in an oxygen atmosphere. This process develops a thin and uniform layer of metal oxide on the ferromagnetic particles. The controlled oxidation of the coating helps encapsulate the particles with a thermally stable and electrically non-conducting layer. These particles can then be compacted and then annealed above 500 degrees Celsius to relieve the stresses introduced in the shaping, thereby obtaining articles with a high permeability and low magnetic loss.

### BACKGROUND OF THE INVENTION

This invention generally relates to chemical compounds. More particularly, this invention related to insulated magnetic particles. Even more particularly, this invention is related to electrically insulating coatings that are coated on ferromagnetic particles and are thermally stable at high temperatures.

Iron-based magnetic (ferromagnetic) particles are used for a variety of purposes. One of those purposes is as a component in magnetic composite compounds. Magnetic composites compounds are used, in turn, to provide materials with competitive magnetic properties (good relative permeability and magnetic saturation) as well as high electrical resistivity. The high resistivity makes these materials attractive in low eddy current loss applications. High-temperature insulating coatings are often used on the iron particles to facilitate annealing for the reduction of hysteresis loss. Such insulating coatings are required to be electrically insulating as well as thermally stable. The electrical insulation of the coating helps reduce the eddy current loss and the thermal stability facilitates annealing at high temperatures (greater than 500 degrees Celsius) leading to reduction in hysteresis loss and improvement in permeability.

Most high-temperature insulating coatings can be coated on iron particles (or ferromagnetic particles) by a variety of processes. These processes are based on precipitation processes, sol-gel processes, organometallic coating processes, and conversion coating processes. A large number of these processes, however, are not backed by a thermodynamic driver. Therefore, these processes depend on the small particle size or electronegativity of the coating compounds for adhesion and good coverage.

Accordingly, polymer-based coatings have been proposed for ferromagnetic particles. However, these coatings suffer from the inherent low temperature capability of polymers and, therefore, do not allow a high temperature anneal process to be carried out. Instead, low temperature annealing processes must be used and are not able to remove the cold work fully, adversely affecting the permeability of the ferromagnetic particles.

### BRIEF SUMMARY OF THE INVENTION

The invention pertains to coating ferromagnetic particles with a high-temperature insulating coating. The ferromagnetic particles are first coated with a thin layer of a high permeability metal (nickel) by an electroless plating process. The deposited metal layer is then oxidized by controlling the time and temperature while heating the coated particles in an oxygen atmosphere. This process develops a thin and uniform layer of metal oxide on the ferromagnetic particles. The controlled oxidation of the coating helps encapsulate the particles with a thermally stable and electrically non-conducting layer. These particles can then be compacted and then annealed above 500 degrees Celsius to relieve the stresses introduced in the shaping, thereby obtaining articles with a high permeability and low magnetic loss.

The invention includes a method for making a material by providing ferromagnetic particles, coating the particles with a metal layer, oxidizing a portion of the metal layer, and compacting the coated particles. The invention also includes a method for making a material by providing ferromagnetic particles, coating the particles with a metal layer by an electroless plating process, oxidizing a portion of the metal layer, and compacting the coated particles. The invention further includes a method for making a material by providing ferromagnetic particles, coating the particles with a nickel layer by an electroless plating process, oxidizing a portion of the metal layer, compacting the coated particles, and annealing the compacted particles.

The invention includes a method for making a magnetic composite material by providing ferromagnetic particles, coating the particles with a metal layer, oxidizing a portion of the metal layer, and compacting the coated particles. The invention also includes a method for making a magnetic composite material by providing ferromagnetic particles, coating the particles with a metal layer by an electroless plating process, oxidizing a portion of the metal layer, and compacting the coated particles. The invention further includes a method for making a magnetic composite material by providing ferromagnetic particles, coating the particles with a nickel layer by an electroless plating process, oxidizing a portion of the metal layer, compacting the coated particles, and annealing the compacted particles. The invention still further includes magnetic composite materials made by such methods.

The invention includes a magnetic composite material, comprising a plurality of ferromagnetic particles and an insulating coating on the particles, wherein the coating is thermally stable at high annealing temperatures. The invention also includes a magnetic composite material, comprising a plurality of ferromagnetic particles and an insulating coating comprising NiO on the particles, wherein the coating is thermally stable at high annealing temperatures. The invention further includes devices containing such magnetic composite materials.

### BRIEF DESCRIPTION OF THE DRAWINGS

FIGS. 1-2 are views of one aspect of the coated ferromagnetic particles and methods of making such particles according to the invention, in which:

FIG. 1 illustrates an energy dispersive spectroscopy (EDS) spectrum for nickel-coated ferromagnetic particles in one aspect of the invention; and

FIG. 2 illustrates an energy dispersive spectroscopy (EDS) spectrum for NiO-coated ferromagnetic particles in one aspect of the invention.

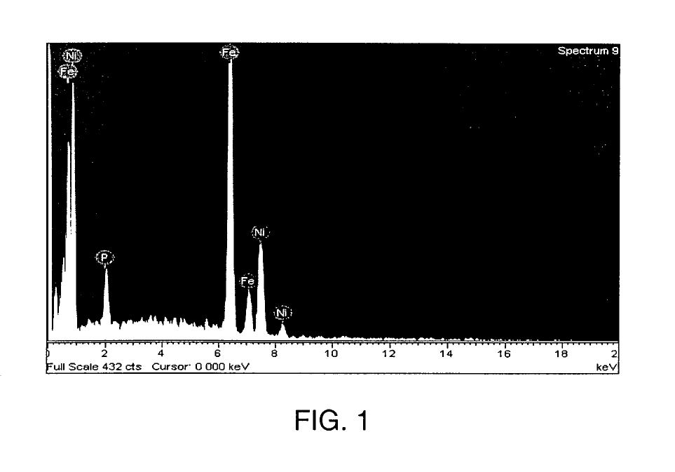

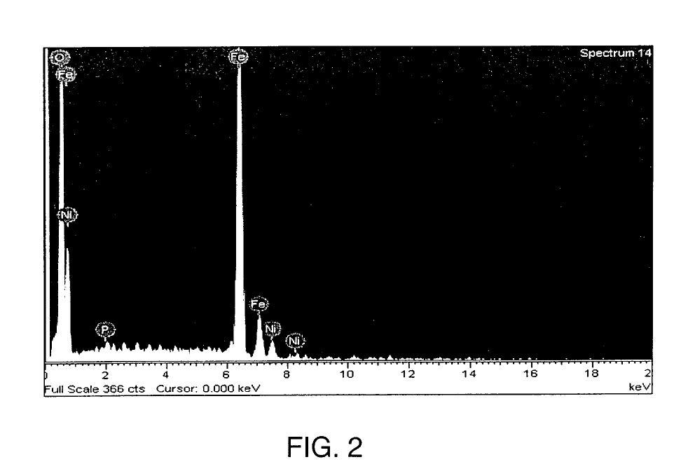

FIGS. 1-2 presented in conjunction with this description are views of only particular-rather than complete-portions of the coated ferromagnetic particles and methods of making such particles in one aspect of the invention. Together with the following description, the Figures demonstrate and explain the principles of the invention.

### DETAILED DESCRIPTION OF THE INVENTION

The following description provides specific details in order to provide a thorough understanding of the invention. The skilled artisan, however, would understand that the invention can be practiced without employing these specific details. Indeed, the present invention can be practiced by modifying the illustrated system and method and can be used in conjunction with apparatus and techniques conventionally used in the industry.

The invention generally pertains to insulating coatings on ferromagnetic particles. Such coatings can be made by any process that provides an electrically insulating, yet thermally stable coating for ferromagnetic particles. In one aspect of the invention, the process described below is used to obtain such coatings.

The process begins by providing ferromagnetic particles. The ferromagnetic particles can be any particles having a low yield strength, such as high purity iron. In one aspect of the invention, pure iron is used as the ferromagnetic particles. The form of the ferromagnetic particles can be any particulate shape, such as spherical particles, fibers, and flakes. The average particle size of the ferromagnetic particles can range from about 100 μm to about 10 mm. In another aspect of the invention, the average particle size can range from about 150 μm to about 250 μm.

The ferromagnetic particles are then cleaned using any known process, if necessary. In one aspect of the invention, the ferromagnetic particles are cleaned with acetone and dilute sulphuric acid to de-grease and de-scale the particles, respectively. The particles are then washed with warm water to remove the traces of acids.

The ferromagnetic particles are then coated with a thin layer of a metal. In one aspect of the invention, such metal is nickel. The metal can be coated by any method known in the art that provides uniform coverage, is backed by a thermodynamic driver, and is cost-effective. Examples of such coating methods include any electroless plating process. In one aspect of the invention, the metal is coated by the electroless plating process described below.

Electroless plating is a chemical reduction process that depends upon the catalytic reduction process of the metal (nickel) ions in an aqueous solution (containing a chemical reducing agent) and the subsequent deposition of the metal without the use of electrical energy. In the plating process, the driving force for the reduction of the metal ions and their deposition is supplied by a chemical reducing agent in the solution.

In one aspect of the invention, the electroless plating process operates with an electroless nickel plating bath containing nickel sulphate as the electrolyte and sodium hypophosphite as the reducing agent. The bath also contains complexing agents, accelerators, and inhibitors. The plating bath is prepared by adding the necessary quantity of nickel sulphate and sodium hypophosphite to water. The bath is maintained between 85 to 95 degrees Celsius. The ferromagnetic particles are brought in contact with the bath and then stirred gently, e.g., from about 40 to about 60 rpm.

For any given bath composition, the plating process is continued for a time sufficient to provide the desired coating thickness of the metal on the ferromagnetic particles. In one aspect of the invention, the coating thickness can range from about 0.1 μm to about 0.5 μm. In another aspect of the invention, the coating thickness can range from about 0.1 μm to about 0.3 μm. The coated particles can then be filtered, washed with water to make it free of chemicals, and dried.

The deposited metal (nickel) layer is then oxidized by any suitable process that forms a thin and uniform layer of metal oxide (NiO) on the ferromagnetic particles. In one aspect of the invention, the metal layer is oxidized by heating in an oxidizing atmosphere. The oxidation of the coating helps encapsulate the particles with a thermally stable and electrically non-conducting layer. The oxidation process operates for a time ranging from about 5 to about 15 minutes and at a temperature ranging from about 400 to about 600 degrees Celsius. The oxidizing atmosphere contains any form of oxygen, including O₂, as well as other gases such as steam, carbon dioxide, and/or a N₂/O₂ mixture. In one aspect of the invention, the oxidation process can be performed on a thin layer of the nickel-coated ferromagnetic power in a crucible.

The oxidation process is continued until the desired amount of oxidation has occurred. In one aspect of the invention, the oxidation process is performed until substantially all the metal (Ni) is oxidized but before the ferromagnetic particle is oxidized. In another aspect of the invention, the oxidation process is performed until only part of the Ni layer is oxidized. The portion that is oxidized is usually the outer portion of the Ni layer. The oxide layer is always kept around 0.1 μm in order to achieve high permeability.

After being coated, the particles are then compacted using any known compaction process. In one aspect of the invention, the particles are compacted using a uniaxial cold compaction process. This compaction process is usually carried out at room temperature and at a pressure ranging from about 60 to about 200 ksi. The particles can be compacted into any desired shape and size. The compaction process generally yields compacts having at least about a 90% relative density. In one aspect of the invention, the compacts have a relative density of about 95% to about 97%.

If desired, the compacted particles can then be annealed. The compacted shapes are annealed to remove the stresses introduced during compaction, thereby achieving a higher permeability and a lower hysteresis loss. The annealing process can be carried out under any conditions that will remove the stress from compaction. In one aspect of the invention, the compacted shapes are annealed at about 400 to about 700 degrees Celsius for about 10 to about 120 minutes. In another aspect of the invention, the compacts are annealed at a temperature ranging from about 500 to about 600 degrees Celsius. The annealing process can be performed in any protective atmosphere, e.g., argon or nitrogen.

The process deposits a thin electrically insulating layer that is amenable to high temperature annealing by virtue of its thermal stability. The constituents of the coating enhance dissolution in the ferromagnetic particles at an elevated temperature without impairing the magnetic properties. Rather, it generally enhances the magnetic properties. In particular, the dissolution of the high permeability metal improves the permeability of the ferromagnetic particles. Thus, the process provides a coating capable of withstanding high annealing temperatures yet that is also beneficial for permeability. By annealing at a higher annealing temperature, the invention ensures better removal of cold work, coarser grains and hence higher permeability and lower hysteresis loss.

In addition, the process is simple, cost-effective and can be easily scaled to the industrial scale. The process does not call for expensive machinery and infrastructure.

Further, the invention deposits a thin insulating layer while ensuring better coverage due the thermodynamic driver intrinsic in the coating process. This thin coating is essential for obtaining high permeability in magnetic composite materials, of which ferromagnetic particles are a major component. The coating is not diamagnetic in nature and, therefore, helps in passage of magnetic flux from one insulated particle to other, benefiting the magnetic permeability of the magnetic composite material. The non-negative susceptibility of the NiO coating also gives better permeability to the materials made from these particles.

As well, the thickness of the insulating coating can be controlled at either the deposition stage or during oxidation. And any unoxidized nickel in the coating is not detrimental to the magnetic properties of the composite body owing to the ferromagnetic properties of the high permeability metal (nickel).

The coated ferromagnetic particles of the invention can be combined with other components as known in the art to make magnetic composite materials. Examples of such components include various kinds of fillers such as fibrous fillers, plate-like fillers, and spherical fillers to improve the mechanical and magnetic properties.

The magnetic composites materials of the invention can be used in the manufacture of numerous devices as known in the art. See, for example, U.S. Pat. Nos. 4,601,765, 5,352,522, 5,595,609, and 5,754,936, as well as U.S. Patent Publication No. US20020023693 A1.

The following non-limiting examples illustrate the invention.

### EXAMPLE 1

Iron particles having a 100 micron average particle size was successively degreased and de-scaled using acetone and dilute sulphuric acid, respectively. The particles was then washed several times with water to remove the traces of acids. The particles was next transferred to a bath containing nickel sulphate and sodium hypophosphite. The bath was maintained at 90 degrees Celsius and gently agitated at a speed of 40 to 60 rpm. The particles was taken out of the bath after 5-15 minutes residence time. The particles was then washed several times with water to remove the traces of electrolyte, and then dried at 105 degrees Celsius.

The dried particles was then oxidized at 600 degree Celsius for 15 minutes in a tubular furnace. The coated particles and the oxidized particles were both observed by scanning electron microscopy (SEM) and energy dispersive spectroscopy (EDS), with the EDS analysis confirming the presence of nickel coating on the iron particles. The EDS spectrum for the nickel-coated particles are illustrated in FIG. 1 and for the oxidized particles are shown in FIG. 2.

The oxidized particles was compacted into 16 mm diameter and 5 mm thick pellets at a compaction pressure of 177 ksi. The compacted pellets were then annealed at 800 degrees Celsius in a nitrogen atmosphere for 30 minutes. The annealed pellets were cut across the thickness of the pellet, and the microstructure of the cut section observed. The microstructure revealed an oxidized layer of nickel oxide enveloping the iron particles.

### EXAMPLE 2

In another example, iron particles with a 150 μm average particle size was taken and degreased with acetone. The oxide scale on the iron particles was then removed by pickling in 1% v/v sulphuric acid solution. The particles was next washed in hot (70° C.) water.

Next, an electroless plating solution containing 40 ml/l electrolyte and 160 ml/l reducing agent (sodium hypophosphite) was prepared and heated to 88° C. The iron particles was poured in the solution (with a particles to coating solution ratio of 0.16 w/v) and agitated with a stirrer for 3 minutes at 40 rpm. The iron particles was filtered out and washed with water to free it from the coating solution. The washed particles was then dried in the oven at 105° C.

The dried particles was next put in a crucible and oxidized at 400° C. for 5 minutes in air. The oxidized particles were then compacted at 177 ksi in the form of rings for magnetic testing. The compact was next annealed at 600° C. for 30 minutes in nitrogen gas. The compacted particles were measured with a density of 7.66 g/cm³. The peak permeability of the compact (at 60 Hz) was found to be 579. The core loss for the compact (at 60 Hz and 1 T) was measured to be 7.23 W/lb. The coating thickness was found to be 0.30 μm. The electrical resistivity was measured and found to be 0.046 mOhm-cm. The Transverse Rupture Strength was measured and found to be 100 MPa.

Having described these aspects of the invention, it is understood that the invention defined by the appended claims is not to be limited by particular details set forth in the above description, as many apparent variations thereof are possible without departing from the spirit or scope thereof.

What is claimed is:

1. A method for making a material, comprising:
providing ferromagnetic particles;
coating the particles with a metal layer;
oxidizing a portion of the metal layer; and
compacting the coated particles.

2. The method of claim 1, further including annealing the compacted particles.

3. The method of claim 1, wherein the ferromagnetic particles comprises iron.

4. The method of claim 1, wherein the metal layer comprises nickel.

5. The method of claim 1, including coating the particles by electroless plating.

6. The method of claim 5, including coating the particles until a thickness of about 0.1 μm to about 0.5 μm is obtained.

7. The method of claim 1, including oxidizing substantially all of the metal layer.

8. The method of claim 1, wherein oxidizing the metal forms an insulating layer.

9. The method of claim 2, including annealing the compacted particles at a temperature ranging from about 500 to about 700 degrees Celsius.

10. A method for making a material, comprising:
providing ferromagnetic particles;
coating the particles with a metal layer by an electroless plating process;
oxidizing a portion of the metal layer; and
compacting the coated particles.

11. The method of claim 10, further including annealing the compacted particles.

12. The method of claim 11, including annealing at a temperature ranging from about 500 to about 700 degrees Celsius.

13. The method of claim 1, wherein the ferromagnetic particles comprises iron.

14. The method of claim 1, wherein the metal layer comprises nickel.

15. The method of claim 1, including oxidizing substantially of the metal layer.

16. A method for making a material, comprising:
providing ferromagnetic particles;
coating the particles with a nickel layer by an electroless plating process;
oxidizing a portion of the metal layer;
compacting the coated particles; and
annealing the compacted particles.

17. The method of claim 16, including coating the particles until a thickness of about 0.1 μm to about 0.5 μm is obtained and then oxidizing the nickel coating to a thickness of about 0.1 μm.

18. A method for making a magnetic composite material, comprising:
providing ferromagnetic particles;
coating the particles with a metal layer;
oxidizing a portion of the metal layer; and
compacting the coated particles.

19. A method for making a magnetic composite material, comprising:
providing ferromagnetic particles;
coating the particles with a metal layer by an electroless plating process;
oxidizing a portion of the metal layer; and
compacting the coated particles.

20. A method for making a magnetic composite material, comprising:
providing ferromagnetic particles;
coating the particles with a nickel layer by an electroless plating process;
oxidizing a portion of the metal layer;
compacting the coated particles; and
annealing the compacted particles

21. A magnetic composite material made by the method, comprising:
providing ferromagnetic particles;
coating the particles with a metal layer;
oxidizing a portion of the metal layer; and
compacting the coated particles.

22. A magnetic composite material made by the method, comprising:
providing ferromagnetic particles;
coating the particles with a metal layer by an electroless plating process;
oxidizing a portion of the metal layer; and
compacting the coated particles.

23. A magnetic composite material made by the method, comprising:
providing ferromagnetic particles;
coating the particles with a nickel layer by an electroless plating process;
oxidizing a portion of the metal layer;
compacting the coated particles, and;
annealing the compacted particles.

24. A magnetic composite material, comprising:
a plurality of ferromagnetic particles; and
an insulating coating on the particles, wherein the coating is thermally stable at high annealing temperatures.

25. The material of claim 24, wherein the ferromagnetic particles comprise iron.

26. The material of claim 24, wherein the insulating coating comprises NiO.

27. The material of claim 24, wherein the annealing temperatures is greater than about 400 degrees Celsius.

28. The material of claim 27, wherein the annealing temperatures range from about 500 to about 700 degrees Celsius.

29. The material of claim 24, wherein the material has a relative density of about 95% to about 97%.

30. The material of claim 24, further comprising a layer containing a metal between the ferromagnetic particle and the insulating coating.

31. A magnetic composite material, comprising:
a plurality of ferromagnetic particles; and
an insulating coating comprising NiO on the particles, wherein the coating is thermally stable at high annealing temperatures.

32. A device containing a magnetic composite material, comprising:
a plurality of ferromagnetic particles; and
an insulating coating on the particles, wherein the coating is thermally stable at high annealing temperatures.

33. A device containing a magnetic composite material, comprising:
a plurality of ferromagnetic particles; and
an insulating coating comprising NiO on the particles, wherein the coating is thermally stable at high annealing temperatures.
